(19) United States
(12) Patent Application Publication
(10) Pub. No.: US 2026/0186714 A1
(43) Pub. Date: Jul. 2, 2026

(54) ADAPTIVE COMPUTATIONAL STORAGE

(71) Applicant: International Business Machines Corporation, Armonk, NY (US)

(72) Inventors: Shravan Kumar RAGHU, Austin, TX (US); Amit LAMBA, Buffalo Grove, IL (US); Akila Srinivasan, Carpentersville, IL (US)

(21) Appl. No.: 19/001,757

(22) Filed: Dec. 26, 2024

(51) Int. Cl. G06F 3/06

(52) U.S. Cl. CPC G06F 3/067; G06F 3/0604; G06F 3/0635

(57) ABSTRACT

Methods, computer program products, and systems are presented. The method computer program products, and systems can include: receiving, by an object storage system, source data of a tenant, wherein the object storage system includes a first processing and storage infrastructure group, and a second processing and storage infrastructure group, wherein processing and storage infrastructure resources of the second processing and storage infrastructure group are differentiated from processing and storage infrastructure resources of the second processing and storage infrastructure group; examining setting data associated to the source data; selecting, in dependence on the examining, one of the first or second processing and storage infrastructure group; routing the source data to the selected one of the first or second processing and storage infrastructure group; and storing the source data into a storage device of the selected one of the first or second processing and storage infrastructure group.

Embodiments herein relate generally to storage and particularly to adaptive computational storage.

Object storage herein refers to a scalable data storage architecture that organizes data as discrete units called objects, each of which can include the data itself, metadata for detailed organization, and a unique identifier for easy retrieval. Unlike traditional file or block storage, object storage can be configured to handle vast amounts of unstructured data and is accessed via HTTP APIs rather than a file system. Object storage can feature horizontal scalability, high durability through data replication, and metadata-driven organization, making it suitable for cloud storage services like as well as for use cases such as backup and archiving, storing large media files, and supporting big data analytics. Object storage can be configured for environments benefitting from flexibility, durability, and seamless handling of large-scale unstructured data.

Data structures have been employed for improving operation of computer system. A data structure refers to an organization of data in a computer environment for improved computer system operation. Data structure types include containers, lists, stacks, queues, tables, and graphs. Data structures have been employed for improved computer system operation e.g., in terms of algorithm efficiency, memory usage efficiency, maintainability, and reliability.

Artificial intelligence (AI) refers to intelligence exhibited by machines. Artificial intelligence (AI) research includes search and mathematical optimization, neural networks, and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided, through the provision, in one aspect, of a method. The method can include, for example: receiving, by an object storage system, source data of a tenant, wherein the object storage system includes a first processing and storage infrastructure group, and a second processing and storage infrastructure group, wherein processing and storage infrastructure resources of the second processing and storage infrastructure group are differentiated from processing and storage infrastructure resources of the second processing and storage infrastructure group; examining setting data associated to the source data; selecting, in dependence on the examining, one of the first or second processing and storage infrastructure group; routing the source data to the selected one of the first or second processing and storage infrastructure group; and storing the source data into a storage device of the selected one of the first or second processing and storage infrastructure group.

In another aspect, a computer program product can be provided. The computer program product can include a computer readable storage medium readable by one or more processing circuit and storing instructions for execution by one or more processor for performing a method. The method can include, for example: receiving, by an object storage system, source data of a tenant, wherein the object storage system includes a first processing and storage infrastructure group, and a second processing and storage infrastructure group, wherein processing and storage infrastructure resources of the second processing and storage infrastructure group are differentiated from processing and storage infrastructure resources of the second processing and storage infrastructure group; examining setting data associated to the source data; selecting, in dependence on the examining, one of the first or second processing and storage infrastructure group; routing the source data tenant to the selected one of the first or second processing and storage infrastructure group; and storing the source data into a storage device of the selected one of the first or second processing and storage infrastructure group.

In a further aspect, a system can be provided. The system can include, for example, a memory. In addition, the system can include one or more processor in communication with the memory. Further, the system can include program instructions executable by the one or more processor via the memory to perform a method. The method can include, for example: receiving, by an object storage system, source data of a tenant, wherein the object storage system includes a first processing and storage infrastructure group, and a second processing and storage infrastructure group, wherein processing and storage infrastructure resources of the second processing and storage infrastructure group are differentiated from processing and storage infrastructure resources of the second processing and storage infrastructure group; examining setting data associated to the source data; selecting, in dependence on the examining, one of the first or second processing and storage infrastructure group; routing the source data to the selected one of the first or second processing and storage infrastructure group; and storing the source data into a storage device of the selected one of the first or second processing and storage infrastructure group.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system having a storage manager system, enterprise systems, and user equipment (UE) devices according to one embodiment;

FIG. 2 depicts a computer environment according to one embodiment;

FIG. 3 is a flowchart illustrating a method for performance by a storage manager system interoperating with enterprise systems and UE devices according to one embodiment;

FIG. 4 depicts a user interface according to one embodiment;

FIG. 5 depicts predicting with use of a machine learning model according to one embodiment;

FIG. 6 depicts a computing environment according to one embodiment.

### DETAILED DESCRIPTION

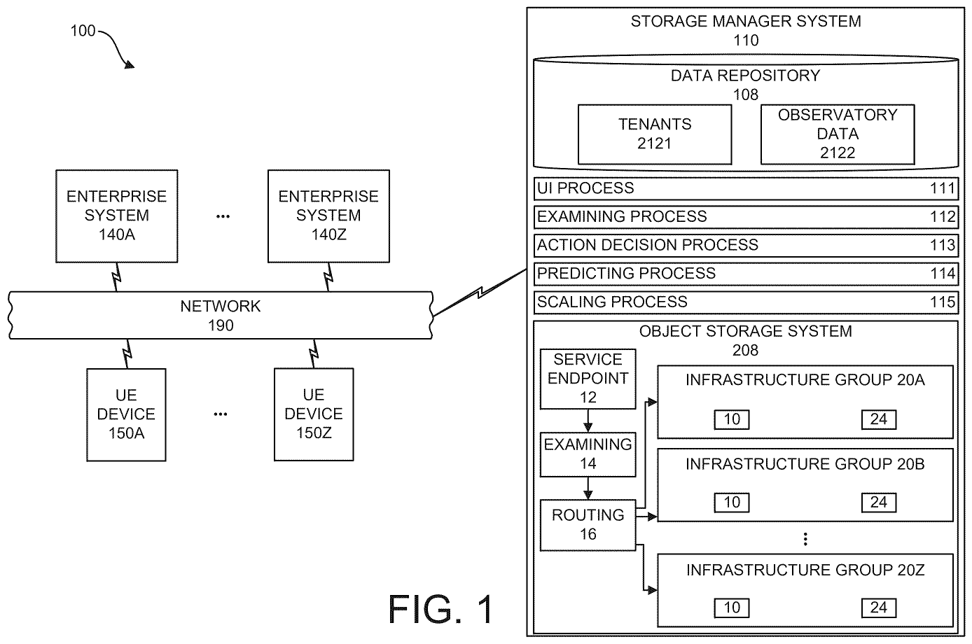

System 100 for providing enhanced object storage is set forth in reference to FIG. 1. System 100 can include storage manager system 110 having an associated data repository 108 and object storage system 208, enterprise systems 150A-150Z, and user equipment (UE) devices 150A-150Z. Storage manager system 110, enterprise systems 140A-140Z, and UE devices 150A-150Z can be computing the node based systems in communication with one another via network 190. Network 190 can be a physical network and/or a virtual network. A physical network can be, for example, a physical telecommunications network connecting numerous computing nodes or systems, such as computer servers and computer clients. A virtual network can, for example, combine numerous physical networks or parts thereof into a logical virtual network. In another example, numerous virtual networks can be defined over a single physical network.

Enterprise systems 140A-140Z can be computing node based systems of various enterprises. Such various enterprises can define tenant users (tenants) of object storage system 208.

UE devices 150A-150Z can be associated to users of system 100. Users of system 100 can include agent users of enterprise systems 140A-140Z and/or agent users of storage manager system 110. An agent user of a UE device of UE devices 150A-150Z can configure object storage system 208 to perform data storage in accordance with use of particular setting data that can be entered and defined using a user interface.

An agent user of enterprise systems 140A-140Z can specify setting data that configures how data for storage of a particular enterprise is to be stored, and optionally, processed by object storage system 208. Embodiments herein recognize that currently available object storage systems provide limited options to tenant users in regard to the configurations of objects storage. In one aspect, embodiments herein recognize users of currently available object storage systems perform a range of resource consuming, high latency, manual and/or ad hoc data preparation processes prior to storage of their enterprise's source data designated for storage into an object storage system into an object storage system.

Storage manager system 110 can manage object storage system 208. Object storage system 208 can include service endpoint 12, examining block 14, routing block 16, and processing and storage infrastructure groups 20A-20Z. Each respective processing and storage infrastructure group 20A-20Z can include one or more computing node 10 and storage infrastructure 24 provided by one or more storage device.

Operation of object storage system 208 can be further understood with reference to the schematic diagram depicted in FIG. 1. Incoming source data for persisting in an object storage system from enterprise systems 140A-140Z together with in some instances agent user defined setting data can be received by service endpoint 12. Storage manager system 110 at examining block 14 can perform examining of the incoming source data for persisting in an object storage system and/or setting data and can perform appropriate routing of the incoming source data by routing block 16 based on the examining. In one embodiment, service endpoint 12 can define a single service endpoint URL as a centralized access point for all tenants. Tenants can be defined by enterprises associated to enterprise systems 140A-140Z. Object storage system 208 can be configured to distinguish tenants through unique credentials, namespace isolation, or bucket names, while the backend handles routing. The described configuration can provide uniform APIs, and can enable centralized management. In some cases, multiple endpoints can be employed for region-specific access, custom domains, or dedicated tenancy for stricter isolation.

Object storage system 208 can be configured to provide object storage. Object storage herein refers to a scalable data storage architecture that organizes data as discrete units called objects, each of which can include the data itself, metadata for detailed organization, and a unique identifier for easy retrieval. Unlike traditional file or block storage, object storage can be configured to handle vast amounts of unstructured data and is accessed via HTTP APIs rather than a file system. Object storage can feature horizontal scalability, high durability through data replication, and metadata-driven organization, making it suitable for cloud storage services like as well as for use cases such as backup and archiving, storing large media files, and supporting big data analytics. Object storage can be configured for environments benefitting from flexibility, durability, and seamless handling of large-scale unstructured data.

Object storage by object storage system 208 can be highly scalable, capable of storing vast amounts of data in the petabyte or exabyte range, making it ideal for big data applications and long-term archiving. It can be designed with a flat address space, simplifying data retrieval by using unique identifiers instead of hierarchical file systems. Object storage can be metadata-rich, enabling the attachment of contextual information like file type, creation date, and tags for efficient organization, search, and analytics. It can be accessed flexibly through APIs, supporting cloud-native and distributed applications. Durability and high availability can be achieved by replicating data across multiple nodes or regions, ensuring reliability and preventing data loss. Object storage can be cost-efficient, optimized for storing massive amounts of infrequently accessed unstructured data such as videos, logs, and backups. Objects stored can be immutable, enhancing data integrity and making the system suitable for compliance and security purposes. It can be geo-distributed, ensuring global accessibility, low latency, and adherence to regional data regulations. Without traditional file system overheads, object storage can be free from scalability constraints, simplifying storage management. It can be well-integrated with cloud platforms like AWS S3, Azure Blob Storage, and Google Cloud Storage, supporting seamless use in cloud-native applications. Additionally, object storage can be ideal for write-once, read-many (WORM) use cases, making it a perfect solution for backups, logs, and compliance-related data. These features collectively highlight the versatility and efficiency of object storage for handling and archiving large-scale unstructured data.

In the context of object storage by object storage system 208, unstructured data refers to data that lacks a predefined schema or organization, distinguishing it from structured data stored in databases with fixed rows and columns. Instead, unstructured data is stored in its raw or binary format, such as images, videos, audio files, logs, and documents, with its structure and meaning defined by application-specific metadata. Each object in object storage is self-describing, combining the raw data with rich metadata that provides context, such as timestamps, resolution, or tags, enabling advanced organization and retrieval. This type of data often varies in size and complexity, from small text logs to massive multimedia files, and its flexibility allows it to be stored as-is without requiring prior transformation into a fixed format. Object storage is uniquely suited to handle unstructured data due to its scalability, accommodating billions of objects across distributed systems, and its ability to manage metadata effectively, which enhances search and tagging capabilities. The schema-free nature of unstructured data aligns with object storage's flexible API-based access, global availability, and cost-effective design for large-scale, infrequently accessed datasets like archives, backups, and IoT logs. Examples include multimedia files, IoT sensor data, JSON configurations, and research datasets like genome sequences or satellite images. Object storage provides a robust solution for managing unstructured data, offering scalability, durability, and accessibility for modern data-driven applications.

Data repository 108 in tenants area 2121 can store data on tenant users of system 100. Tenant users (tenants) of system 100, storage manager system 102 and object storage system 208 can map to enterprises of enterprise systems 140A-140Z. Storage manager system 110, according to one embodiment, can be configured to provide object storage services to multiple tenants. Tenant data of tenants area 2121 can include, e.g., a list of tenants for which storage manager system 110 is providing storage management services. Associated to each tenant listed in tenants area, 2021 there can be stored setting data. Such setting data can specify, e.g., data sources from which source data for persisting in an object storage system is to be sent, and processing function(s) associated to source data of various data sources.

Further, storage manager system 110 in observatory data area 2122 can store observatories data that specifies attributes of objects storage system 208 managed by storage manager system 110. Observatory data stored in observatory data area 2122 can include, e.g., logging data and/or metrics data indicative of demand for processing and/or storage resources of storage infrastructure resource groups. Observatory data stored in observatory data area 2122 can include logging or metrics parameter values indicating a demand on processing resources and/or storage resources of object storage system 208. To assess processing and storage demand in an object storage system, storage manager system 110 can monitor request metrics (rate, latency, error rates, operation types), resource utilization (CPU, memory, I/O, network), and concurrency (connections, thread usage). To assess processing and storage demand in an object storage system, storage manager system 110 can track storage metrics like utilization, growth, object count, size distribution, throughput, latency, and queue depth. To assess processing and storage demand in an object storage system, storage manager system 110 can analyze archival, deletion rates, access patterns, and hotspots to identify bottlenecks, predict growth, and optimize performance.

Tenant source data for storage defines workloads in object storage system 208. Source data can generate specific demands on processing, storage, and network resources, especially during the migration and organization phases. In one aspect, archiving can include identifying, organizing, and tagging data for long-term storage, which requires CPU and memory resources. According to aspects herein, object storage system 208 can, e.g., transform, compress, encrypt source data increasing workload. In one aspect, archival policies or lifecycle management tools execute rules (e.g., “archive objects older than X days”), requiring system overhead. In one aspect, archived data requires dedicated capacity, potentially across different storage tiers optimized for cost-efficiency (e.g., cold storage). In one aspect, migrating data to object storage system 208 can generate significant network traffic, particularly in distributed systems or cloud-based storage where data is transferred between nodes or regions. In one aspect, archiving can trigger periodic maintenance workloads, such as integrity checks or rebalancing in storage systems.

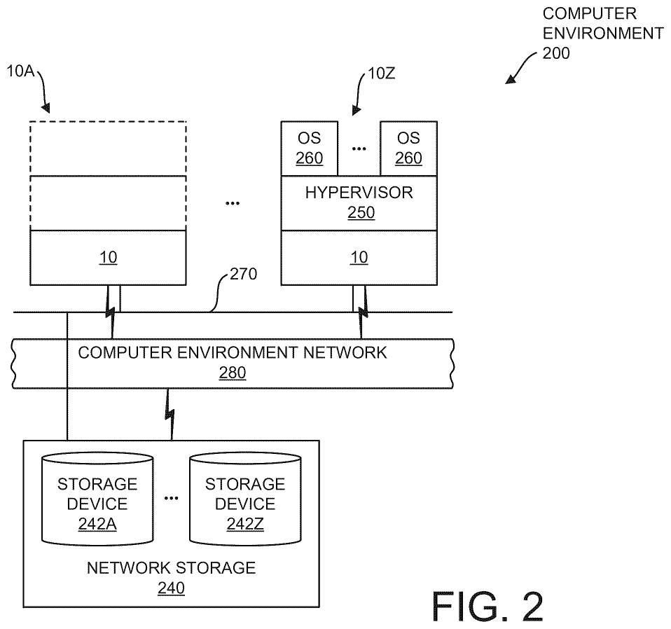

FIG. 2 depicts an example infrastructure defining a computer environment 200 for hosting object storage system 208. Computer environment 200 is set forth in reference to the infrastructure view of FIG. 2. Computer environment 200 can include a plurality of computing nodes 10, which can be provided by physical computing nodes. Object storage system 208 can be hosted on one or more computing node 10 of computer environment 200, e.g., via or without intermediary virtual machine (VM) software.

The respective computing nodes 10 can have software running thereon defining computing node stacks 10A-10Z. Software defining the respective instances of computing node stacks 10A-10Z can be differentiated between the computing node stacks, e.g., some stacks can provide traditional bare metal machine operation, other stacks can include a hypervisor 250 that supports a plurality of guest operating systems (OS) 260 defining respective guest hypervisor based virtual machines (VMs), other stacks can include container based VMs, e.g., running on top of a hypervisor based VM or running on a computing node stack that is absent of a hypervisor. A plurality of different configurations are possible. Software defining the respective instances of computing node stacks 10A-10Z can include application layer software which when run can perform various processes, e.g., processes of a storage system controller and/or processes 111-115 of storage manager system 110.

Referring to further aspects of computer environment 200, computer environment 200 can include network storage 240. network storage 240 can include storage devices 242A-242Z, which can be provided by physical storage devices. Physical storage devices of network storage 240 can include associated controllers defined by one or more computing node stack of computing node stacks 10A-10Z. Storage devices of computer environment 200 can also include storge devices of computing nodes 10, i.e., direct attached storage (DAS). Storage devices of computing nodes 10 and storage devices 242A-242Z can be provided, e.g., by hard disk drives (HDDs) and Solid-State Storage Devices (SSDs).

Network storage 240 can be in communication with computing node stacks 10A-10Z by way of a Storage Area Network (SAN) and/or a Network Attached Storage (NAS) link. According to one embodiment, computer environment 200 can include fibre channel network 270 providing communication between respective computing node stacks 10A-10Z and network storage 240. Fibre channel network 270 can include a physical fibre channel that runs the fibre channel protocol to define a SAN. NAS access to network storage 240 can be provided by computer environment network 280 which can be an IP based network. Network 190 set forth in the logical system view of FIG. 1 can be defined by one or more of fibre channel network, and/or computer environment network 280. Computer environment 200 can be configured to provide cloud computing services. Computer environment 200 can be provided in one embodiment, e.g., by one or more data center. Computer environment 200 can be provided, e.g., by a single data center such that all components of object storage system 208 are hosted in a single data center.

In one embodiment, areas 2121 and 2122 of data repository 108 can map in infrastructure space to one or more storage device of storage devices 242A-242Z.

Data sources for generating observatory data herein can be provided, e.g., by logging agents disposed appropriately within computer environment 200 for generating log messages, e.g., application log messages, system log messages, security log messages, audit log messages, transaction log messages, and event log messages. Data sources for generating observatory data herein can comprise, e.g., logging agents of applications, which produce application log messages, logging agents of operating systems which include system log messages, logging agents which produce security log messages, logging agents which produce audit log messages, logging agents which produce transaction log messages, and logging agents which produce event log messages. Data sources for generating observatory data herein can additionally or alternatively be provided, e.g., by metrics data generating agents that generate metrics data of one or more of the metrics data types herein.

Computing nodes 10 of processing and storage infrastructure groups 20A-20Z can be provided by computing nodes 10 of computer environment 200. Storage devices defining storage infrastructure 24 of processing and storage infrastructure groups 20A-20Z can be provided by DAS storage devices of computing nodes 10 of computer environment 200 and/or storage devices 242A-24Z of network storage of computer environment 200. Computing nodes 10 can be of varying types, e.g., standard computing node or graphics processing unit (GPU) computing node. In performing scaling in accordance with scaling process 115, storage manager system 110 can increase or decrease an allocation of computing nodes 10 to respective ones of processing and storage infrastructure groups 20A-20Z. In performing scaling in accordance with scaling process 115, storage manager system 110 can increase or decrease an allocation of storage devices to respective ones of processing and storage infrastructure groups 20A-20Z.

Storage manager system 110 can run various processes. Storage manager system 110 running user interface (UI) process 111 can include storage manager system 110 presenting a user interface to an agent user of an enterprise system of enterprise systems 140A-140Z.

Storage manager system 110 running examining process 112 can include storage manager system 110 performing examining of one or more of incoming source data for persisting in an object storage system sent from one or more enterprise of enterprise systems 140A-140Z or setting data of a tenant associated to the incoming source data. Setting data can be entered into a user interface provided by storage manager system 110 running UI process 111. Examining of source data for persisting in an object storage system by examining process 112 can include, e.g., examining incoming source data to ascertain the data type. Examining of setting data can include examining setting data, e.g., specifying source of source data, type of source data, processing function to be performed on source data, and/or processing and storage infrastructure group.

Storage manager system 110 running action decision process 113 can include storage manager system 110 returning an action decision in dependence on an examining of one or more of source data for persisting in an object storage system and/or setting data associated with such source data performed by examining process 112.

Storage manager system 110 running action decision process 113 can include storage manager system 110 returning an action decision to select a particular one processing and storage infrastructure group of processing and storage infrastructure groups 20A-20Z and to route incoming source data to a particular one processing and storage infrastructure group of processing and storage infrastructure groups 20A-20Z.

In one aspect, object storage system 208 can include a plurality of processing and storage infrastructure groups 20A-20Z. Each of the different processing and storage infrastructure groups 20A-20Z can have associated processing performed by one or more computing node 10. One or more computing node 10 of each processing and storage infrastructure group 20A can perform processing for improved data storage.

The one or more computing node associated to each processing and storage infrastructure group 20A-20Z can be configured based on data type of the processing and storage infrastructure group of infrastructure groups 20A-20Z. Different processing and storage infrastructure group of infrastructure groups 20A-20Z can be provided for each of a plurality different source data types for persisting in an object storage system. For example, a first processing and storage infrastructure group 20A can be provided for processing of media data, a second processing and storage infrastructure group 20B can be provided for processing of machine learning data, a third processing and storage infrastructure group can be provided for processing and storing of non-visual sensor data. In another aspect, each of the different processing and storage infrastructure group processing and storage infrastructure group of infrastructure groups 20A-20Z can be capable of performing processing functions. In accordance with aspects herein processing and storage resources of the different processing and storage infrastructure group of infrastructure groups 20A-20Z can be configured differently in dependence on expected differences between workloads of the of the different processing and storage infrastructure group of infrastructure groups 20A-20Z.

In another aspect, embodiments herein feature processing and storage infrastructure group of infrastructure groups configured to perform predetermined sets of processing functions, wherein the sets of processing function can be differentiated in dependence on data type classification of the group. Processing functions herein can perform functions for improved data storage.

A breakdown of differentiated processing functions, computing node allocation, and storage device allocation of processing and storage infrastructure groups of infrastructure groups 20A-20Z, in one embodiment, is set forth in reference to Table A.

TABLE A

| | | | Computing node | Storage device |
|---|---|---|---|---|
| Processing and | Data type (data | Processing | resource | resource |
| storage Group | classifier) | functions | allocation | allocation |
| 20A | Multimedia | e.g., transcoding, | 100% GPU | 50% SSD, 50% |
| | | format | | HDD |
| | | conversion, and | | |
| | | compression | | |
| 20B | Machine Learning | e.g., data cleaning, | 20% GPU, 80% | 20% SSD, 80% |
| | | data | standard | HDD |
| | | transformation, | | |
| | | feature | | |
| | | engineering, and | | |
| | | for video data pre- | | |
| | | processed for | | |
| | | machine learning | | |
| | | and adapting | | |
| | | archived data for | | |
| | | use as training | | |
| | | data: Frame | | |
| | | Extraction and | | |
| | | Selection, | | |
| | | Resizing and | | |
| | | Rescaling, Noise | | |
| | | Reduction, Data | | |
| | | Augmentation, | | |
| | | Feature | | |
| | | Extraction, | | |
| | | Dimensionality | | |
| | | Reduction, | | |
| | | Annotation and | | |
| | | Labeling, Adding | | |
| | | Transcripts | | |
| 20C | Non-visual sensor | Data Cleaning, | 100% standard | 100% HDD |
| | | Data | | |
| | | Standardization, | | |
| | | Metadata | | |
| | | Enrichment, Data | | |
| | | Segmentation, | | |
| | | Anomaly | | |
| | | Detection and | | |
| | | Flagging, Data | | |
| | | Encoding, | | |
| | | Indexing, Data | | |
| | | Validation, | | |
| | | Aggregation | | |
| 20D | Backup data | e.g., data cleaning, | 100% standard | 100% HDD |
| | | compression, | | |
| | | deduplication, | | |
| | | Encryption, | | |
| | | metadata | | |
| | | enrichment, | | |
| | | segmented and | | |
| | | batched, | | |
| | | validation and | | |
| | | verification, | | |
| | | Archival tier | | |
| | | optimization, | | |
| | | format | | |
| | | conversion, | | |
| | | Indexing and | | |
| | | cataloging, | | |
| | | retention policies | | |
| | | and | | |
| | | anonymization | | |
| . . . | . . . | . . . | . . . | . . . |
| 20Z | Logging | Parsing and | 100% standard | 100% HDD |
| | | Structuring, | | |
| | | Deduplication, | | |
| | | Anonymization | | |
| | | and Security, | | |
| | | Segmentation and | | |
| | | Batching, | | |
| | | Filtering and | | |
| | | Sampling, | | |
| | | Validation and | | |
| | | Integrity Checks, | | |
| | | Transformation | | |
| | | for Analytics | | |

Referring to Table A, processing functions associated to multimedia processing and storage infrastructure group 20A can include transcoding, format conversion, and compression. Embodiments herein recognize that multimedia processing and storage infrastructure group 20A can benefit from including GPUs. Embodiments herein recognize that transcoding, format conversion, and compression can significantly benefit from GPU acceleration due to the parallel processing capabilities of GPUs, which speed up computationally intensive tasks like decoding, re-encoding, and applying complex algorithms. GPUs, with specialized hardware encoders and decoders enable faster transcoding of high-resolution content (e.g., 4K or 8K), real-time processing for streaming, and efficient compression with modern codecs. Embodiments herein recognize that transcoding, format conversion, and compression often involve reading large multimedia files, processing them, and writing the output to disk. SSDs have much faster read/write speeds than HDDs, reducing I/O bottlenecks and improving the overall speed of the workflow.

Referring the processing functions associated to multimedia processing and storage infrastructure group 20B, embodiments herein recognize that Data Cleaning addresses missing values, outliers, and duplicates, which, if left unresolved, can introduce bias, reduce model accuracy, or create erratic behaviors during training. Filling missing values (e.g., with mean or median) maintains dataset integrity, while handling outliers prevents skewed model predictions. Removing duplicates reduces redundancy, ensuring models learn from unique and varied data points. Data Transformation techniques such as normalization and standardization help scale numerical data into comparable ranges, improving the performance of distance-based or gradient-based algorithms like k-means or neural networks. Encoding categorical data through methods like one-hot encoding or label encoding ensures that models interpret non-numeric data correctly without assuming unintended ordinal relationships. Feature Engineering enhances the dataset's predictive power by selecting the most relevant variables, creating meaningful new features, or reducing dimensionality through techniques like PCA. These processes simplify models, improve interpretability, and reduce the risk of overfitting. For imbalanced datasets, techniques such as oversampling (e.g., SMOTE) or weighting help models better learn from minority classes, avoiding bias toward dominant ones. Data Augmentation, like applying transformations to images or text (e.g., rotations, synonym replacement), increases dataset diversity, helping models generalize better to unseen data. Dimensionality Reduction via PCA or t-SNE not only reduces computational complexity but also helps visualize high-dimensional data, aiding in understanding relationships and patterns.

Referring the processing functions associated to machine learning processing and storage infrastructure group 20B, processing video data for machine learning can include various processes to prepare the visual, temporal, and associated data for efficient and accurate model training. Frame Extraction and Selection is a foundational step where individual frames or keyframes are extracted to reduce redundancy and focus on meaningful content, often complemented by downsampling frame rates to manage data volume. Resizing and Rescaling ensures video frames are consistent in resolution (e.g., 224×224) and pixel values are normalized to a standard range (e.g., [0, 1]) for stable model input. Noise Reduction is applied using filters to smooth frames and eliminate compression artifacts, enhancing video quality. Data Augmentation introduces transformations like flipping, cropping, rotation, or speed adjustments to increase diversity and improve model generalization. Feature Extraction focuses on capturing temporal dynamics through motion vectors, optical flow, or background segmentation. To optimize storage and computational demands, Dimensionality Reduction is used, either by compressing spatial resolution or selecting representative clips. Annotation and Labeling adds supervised learning labels such as activity categories, object classes, or timestamps to facilitate model training.

Adding Transcripts involves generating text from spoken content using automatic speech recognition (ASR) tools, pairing transcripts with timestamps for frame-level synchronization, or including captions and metadata to support multi-modal tasks like video-text alignment and accessibility.

Embodiments herein recognize that adding transcripts to video data using automatic speech recognition (ASR) can benefit from a GPU. GPUs significantly accelerate transcription for large-scale datasets, long videos, or real-time applications. Embodiments herein recognize that adding transcripts to videos can benefit significantly from GPUs and SSDs due to their ability to accelerate key processes. GPUs handle computationally intensive tasks like speech-to-text model processing, video decoding, and real-time feedback, leveraging their parallel processing power for fast and accurate transcription. SSDs complement this by ensuring fast read/write speeds, low latency, and efficient handling of large video files and temporary storage, preventing I/O bottlenecks.

Referring the processing functions associated to non-visual sensor processing and storage infrastructure group 20C, Data Standardization ensures consistency by normalizing values, unifying timestamps, and converting units. Metadata Enrichment adds context by recording sensor details, timestamps, and collection settings. Data Segmentation splits long streams into manageable chunks for efficient retrieval. Anomaly Detection and Flagging identifies unusual patterns for future analysis. Data Encoding ensures compatibility by using efficient formats like Parquet or JSON, while Indexing improves searchability based on parameters like time or sensor ID. Data Validation verifies integrity using checksums, and Aggregation summarizes high-frequency data into meaningful intervals for easier storage and analysis. These steps collectively prepare sensor data for secure, efficient, and future-ready archiving.

Referring to backup data processing and storage infrastructure group 20D, backup data refers to copies of files, databases, systems, or digital assets stored for recovery, security, and compliance. Backup data can include full, incremental, differential, database, and system backups, often capturing point-in-time snapshots. Backup data is typically unstructured, long-term, and redundant, making object storage ideal due to its scalability, durability, cost-effectiveness, and global accessibility. Benefits include high durability (e.g., “11 nines”), immutability (WORM), and integration with backup tools like Veeam and cloud services like AWS S3 or Azure Blob Storage. Backup data supports disaster recovery, archival, data migration, and version control, ensuring reliable and efficient data protection in modern storage systems.

Referring to processing functions of backup data processing and storage infrastructure group 20D, processing functions can include data cleaning to remove redundant or obsolete files and validate integrity, compression to reduce storage costs, and deduplication to eliminate duplicates and save space. Encryption ensures security and compliance, while metadata enrichment adds tags and context for improved searchability. Data is often segmented and batched into manageable chunks, with validation and verification ensuring reliability. Archival tier optimization moves infrequently accessed data to cost-effective storage tiers, and format conversion ensures future compatibility. Indexing and cataloging enhance retrieval, while retention policies and anonymization ensure compliance with regulatory requirements. These steps collectively prepare backup data for efficient long-term archiving, secure access, and simplified management.

Referring the processing functions associated to logging data processing and storage infrastructure group 20Z, Data Parsing and Structuring transforms unstructured logs into formats like JSON or Parquet for easier querying, and Deduplication eliminates redundant entries. Anonymization and Security ensure sensitive information is masked or encrypted to protect privacy. Indexing improves searchability by creating indices for key fields like timestamps or log levels, while Segmentation and Batching organizes logs into manageable chunks by time or source. Filtering and Sampling reduces data volume by removing low-priority logs or retaining representative samples, and Validation and Integrity Checks ensure data accuracy using schema validation and checksums. Finally, Transformation for Analytics aggregates logs into summary statistics or trends for future analysis. These steps collectively optimize logging data for efficient storage, easy retrieval, and enhanced usability in object storage systems.

In one embodiment the different processing and storage infrastructure groups 20A-20Z can be logically isolated from one another, so that each group is restricted from performing processing of data other than data stored on its group. In one embodiment the different processing and storage infrastructure groups 20A-20Z can be physically isolated from one another, so that there is no overlap of computing nodes or storage devices between the groups.

Object storage system 208 can route source data for persisting in an object storage system into a particular one processing and storage infrastructure group 20A-20Z in dependence on data type of the incoming source data for persisting in an object storage system. For example, multimedia can be routed to processing and storage infrastructure group 20A, machine learning data (e.g., for training) can be routed to processing and storage infrastructure group 20B, and non-visual sensor data can be routed to a third processing and storage infrastructure group 20C.

Storage manager system 110 running action decision process 113 can include action decisions to perform particularized processing, such as a selected one or more of the described processing functions summarized in Table A, wherein different sets of processing functions can be associated to different processing and storage infrastructure groups of processing and storage infrastructure groups 20A-20Z.

In one aspect, embodiments herein economize computing resources by facilitating pinpoint high accuracy scaling of computing resources for performing objects storage that are accurately aligned to tenant demand and utilization of object storage resources. Storage manager system 110 running predicting process 114 can include storage manager system 110 predicting growth trends and demand for resources of each respective processing and storage infrastructure group of processing and storage infrastructure groups 20A-20Z. Demand determining and scaling can be performed on a per-infrastructure group basis. As a result, instances of undershooting and overshooting of scaling to meet demand can be reduced. Embodiments herein recognize that breaking object storage system 208 into smaller resource groups and scaling them independently works better than managing a monolithic system because it offers greater scalability, cost efficiency, fault isolation, and flexibility. Embodiments herein recognize that independent scaling allows specific components to meet demand without over-provisioning the entire system, ensuring cost-effective resource allocation and reducing waste. Such scaling can isolate failures to specific components, preventing system-wide outages, while enabling fine-tuned optimization of resources for specific workloads, such as GPU-optimized servers for compute-heavy tasks or lightweight web servers for front-end operations. This approach also allows for the use of the best-suited technologies for each component, faster deployment cycles with reduced risk, and easier monitoring and debugging to pinpoint bottlenecks or issues. Additionally, group specific scaling can enhance security through granular controls, improve resource utilization by allocating resources where needed, and simplifies migration, scaling, and maintenance without disrupting the entire system. By enabling precise scaling, modular updates, and resilience against faults, this method ensures efficient, flexible, and manageable architecture capable of adapting to varying demands.

Storage manager system 110 performing predicting process 114 can include storage manager system 110 performing predicting of demand growth in dependence on recorded observatory data recorded within data repository 108. Observatory data stored within data repository 108 can include observatory data that specifies current utilization level of resources of each respective processing and storage infrastructure group 20A-20Z over time.

Storage manager system 110 running scaling process 115 can include storage manager system 110 performing scaling of processing and storage infrastructure resources in dependence on result data output by storage manager system 110 performing predicting process 114.

Storage manager system 110 performing scaling process 115 can include, e.g., incrementing or decrementing computing nodes to one or more processing and storage infrastructure group of processing and storage infrastructure groups 20A-20Z. Storage manager system 110 performing scaling process 115 can include storage manager system 110 incrementing or decrementing storage devices allocated to one or more processing and storage infrastructure group of infrastructure groups 20A-20Z.

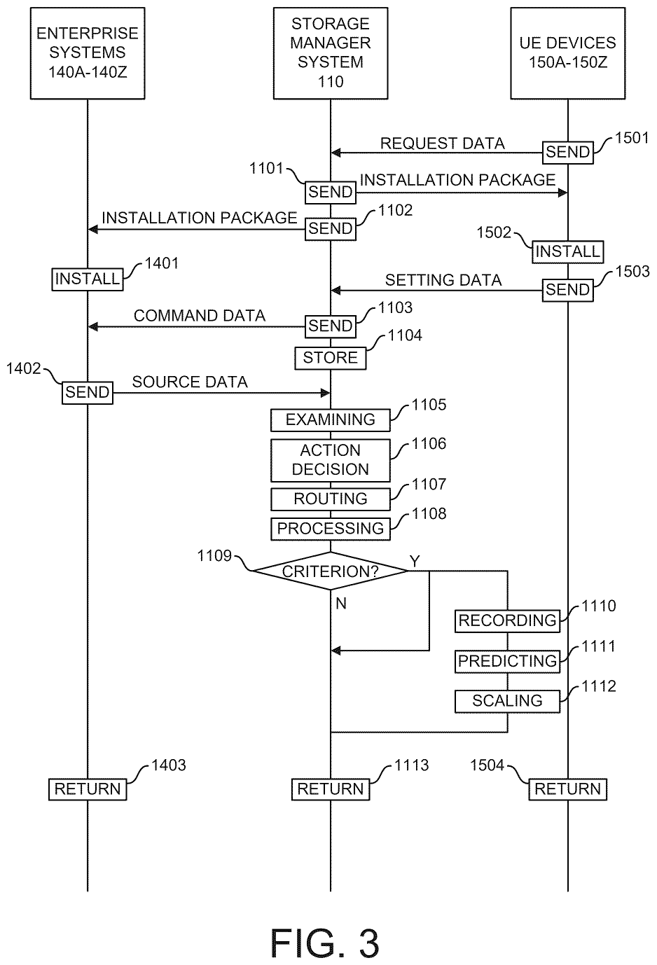

A method for performance by storage manager system 110 interoperating with enterprise systems 140A-140Z and UE devices 150A-150Z is set forth in reference to the flowchart of FIG. 3.

At block 1501, UE devices of UE devices 150A-150Z can be sending request data defined by enterprise agent users of UE devices 150A-150Z. The request data sent at block 1501 can specify, e.g., that a particular enterprise wishes to register as a recipient of services provided by storage manager system 110.

Request data sent at block 1501 can include various other data, e.g., registration data that specifies an identifier of the tenant defining enterprise, and resources of the tenant to which the request pertains. On receipt of the request data sent at block 1501, storage manager system 110 at send block 1101 can send an installation package for installation at UE devices 150A-150Z associated to receipts of request data sent at block 1501.

On receipt of the installation package, the requesting UE devices of UE devices 150A-150Z can perform installation of received installation package of install block 1502. The installation package installed at block 1502 can configure UE devices of UE devices 150A-150Z for operation within system 100.

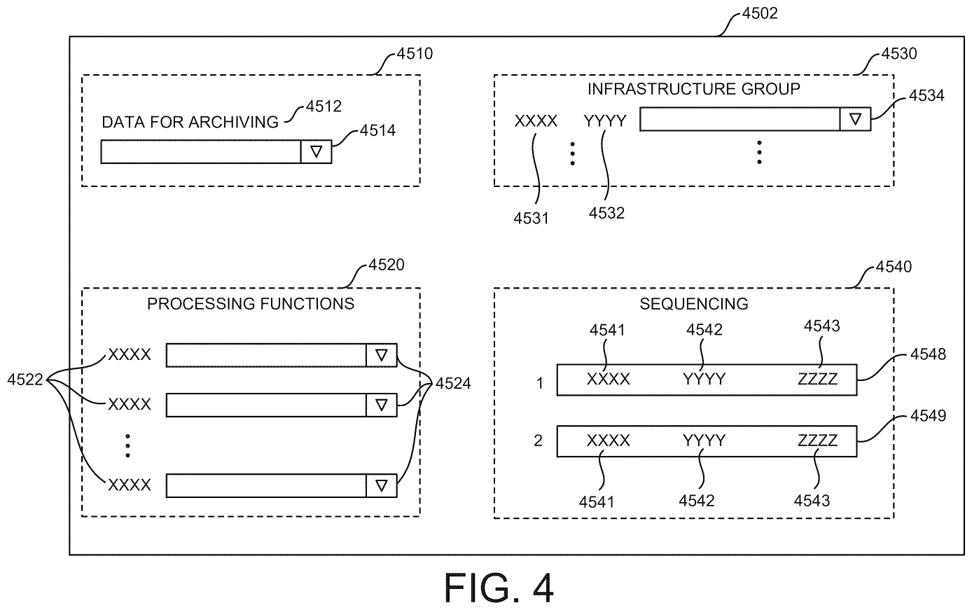

On installation of an installation package installed at block 1502, requesting UE devices of UE devices 150A-150Z can present a configuration user interface, such as user interface 4502 shown in FIG. 4. User interface 4502 can be a displayed user interface displayed on a display of requesting UE devices of UE devices 150A-150Z.

On completion of send block 1101, storage manager system 110 can proceed to send block 1102. At send block 1102, storage manager system 110 can send an installation package to enterprise systems of enterprise systems 140A-140Z associated to enterprises referenced within the request data sent at block 1501.

On receipt of the installation package sent at block 1102, the appropriate enterprise systems of enterprise systems 140A-140Z can perform installation of the installation package sent at block 1102 at install block 1401. The installation package installed at block 1401, once installed, can configure enterprises of enterprise systems 140A-140Z for operation within system 100. The installation package sent at block 1101 and the installation package sent at block 1102 can include, e.g., binaries and executable code for execution.

On completion of installation at installation block 1502 by appropriate ones of UE devices 150A-150Z, the appropriate ones of UE devices of UE devices 150A-150Z can proceed to send block 1503. At send block 1503, the appropriate ones of UE devices 150A-150Z can send setting data. The setting data sent at block 1503 can be setting data defined by an agent user of an enterprise defined with use of user interface 4502.

Regarding user interface 4502, user interface 4502 can include data selection setting area 4510 and processing function setting area 4520. Data selection 4510 can facilitate selection of source data for persisting in an object storage system as indicated by text prompting data 4512. Data selection area 4510 can include, e.g., a drop-down menu 4514 facilitating selection of particular data sources of an enterprise for persisting in an object storage system. In one embodiment, drop-down menu 4514 can display the set of directories from which source data for persisting in an object storage system can be selected. Setting data herein defining selection of certain data source defines setting data for selection of certain source data associated to the data source.

In drop-down menu 4514, there can be presented indicators of various data sources. The various data sources can be defined in one embodiment by different directories. The directories can include directories that do not change over time and/or directories that are iteratively updated over time. A selection of a data source herein can define selection of an instance of source data, e.g., provided by a dataset, e.g., file from the data source.

Automatically detecting the data type of an incoming stream involves a combination of techniques to ensure robust and accurate identification. One approach is to inspect headers or metadata, such as MIME types or schemas, which may directly specify the format. Another is to analyze the content itself through pattern matching, such as using regular expressions for JSON or delimiter checks for CSV, or examining the initial bytes for magic numbers that are unique to certain file types. Machine learning models or statistical methods can infer types based on data characteristics like distributions, value ranges, or entropy levels. Self-describing formats, such as Avro or Parquet, often include embedded schemas that provide precise type information. Contextual heuristics, such as the known source or structure of the stream, can further aid detection, especially for application logs or time-series data. When no single method suffices, a layered approach combining these techniques enhances detection accuracy and adaptability to diverse stream types. In response to a user selecting a data source with defined setting data, storage manager system can sample data from the source to auto-detect data type.

In processing function setting area 4520, there can be presented text data 4522 that specifies data sources and source data selected for transfer, e.g., using drop-down menu 4514. The source data for persisting in an object storage system specified by text data 4522 of processing functions setting area 4520 can adapt over time as different selections are made using drop-down menu 4514 of data selection area 4510. As noted storage manager system 110 can auto-detect data type. In another aspect for presenting processing function options in drop down menus 4524, storage manager system 110 can employ a decision data structure as shown in Table A, wherein different processing function sets are mapped to different data type (data classifier) identifiers.

In processing functions setting are 4520, there can be presented various drop-down menus 4524 facilitating the selection of processing functions with respect to source data selected for transfer to object storage system 208.

The processing functions presented within drop-down menus 4524 can adapt differently depending on the data type of the data source specified in the adjacent instance of text of text area of text 4522 adjacent to each respective drop-down menu 4524. Storage manager system 110 can adapt the presentment of options in area 4520 using the decision data structure of Table A.

For example, with reference to Table A, storage manager system 110 can present a first set of menu options for processing functions can with respect to a data source identifier of source data defined by multimedia and can present a second set of processing function options with respect to a data source identifier that identifies source data defined by machine learning data.

In infrastructure group area 4530, user interface 4502 can present setting options for designating an infrastructure group for performance of performing a processing function and storage. Text 4531 can specify an identifier for a data source and data selected using data selection area 4510 and adjacently thereto there can be displayed text 4532 specifying a processing function for the source data selected using area 4520 and adjacently thereto there can be displayed a drop down menu 4534 enabling selection of a particular processing and storage infrastructure group amongst processing and storage infrastructure groups 20A-20Z as set forth herein for performance of the selected processing on the selected source data from the selected data source.

In one embodiment, storage manager system 110 can be configured so that storage manager system 110 prompts a user for selection of one particular processing storage infrastructure group based on selections of the user made using setting selection area 4510 and/or setting selection area 4520. In one embodiment, storage manager system 110 can be configured so that a user can override any prompted for selection prompted for within drop down menu 4534. Storage manager system 110 can be configured so that a prompted-for group of groups 20A-20Z is auto-selected absent an express setting selection by a user.

In another aspect user interface 4502 can feature sequencing setting selection area 4540. Sequencing selection area 4540 permits selection of a sequence of processing functions. Sequencing selection area 4540 in one embodiment can feature buttons 4548 and 4549. Button 4548 can include text 4541, text 4542 and text 4543. Button 4549 can also include text 4541, text 4542 and text 4543. In each button 4548 and 4549, text 4541 can specify a selected data source and source data for persisting in an object storage system using selection area 4510, text 4542 can specify the processing function associated with the identified data source selected using area 4520 and text 4543 can specify the selected processing and storage resource group selected for performance of the described processing function.

Sequencing area 4540 can be configured to include drag and drop functionality so that a user can move the relative positioning of button 4548 and 4549, e.g., so that button 4549 can be moved upward adjacent to the order ranking “1” and button 4548 can be moved down to be adjacent to ranking order “2” so that the processing function specified in button 4549 will be performed before the processing function specified in button 4548 according to the displayed ordered ranking.

Any number of buttons designating processing functions and source data and groups can be presented within area 4540 to permit a user to specify an ordering of processing functions by various processing and storage infrastructure groups of object storage system 208.

With use of sequencing area 4540, a user can specify that a first processing function is to be performed by a first processing and storage infrastructure group and then a second processing function is to be performed by a second processing and storage infrastructure group. User interface 4502 can be configured so that buttons such as buttons 4548 and 4549 are commonly presented within sequencing area 4540 when storage manager system 110 recognizes that the same data source and source data have been selected for storage and processing. In other words, the particular buttons 4548 and 4549 specified in FIG. 4 can be presented when storage manager system 110 detects that the same data source and source data have been selected for storage into object storage system 208 and have also been selected (using area 4520) for a particular processing function having an indicator that is differentiated between button 4548 and 4549.

With use of sequencing area 4540, a user can be prompted to define setting data that specifies a storage order in respect to each processing function selected using area 4520, e.g., whether the processing function is to be performed prior to or subsequent to a persisting of source data defined by a source data dataset into storage infrastructure 24 of a particular processing and storage infrastructure group.

With use of sequence area 4540 a user can configure a multi-stage workflow defined by processing functions performed on source data that has been persisted in object storage system 208. Object storage system 208 avoids instances where an agent user of a tenant enterprise configures a range of computing resource consuming, high latency, manual and/or ad hoc data preparation processes prior to storage of their enterprise's source data within an object storage system.

Setting data established with an identifier of a selected data source and certain source data dataset presented, e.g., setting data established with drop down menus 4524, 4534, or area 4540 can define setting data associated to the certain source data dataset.

On receipt of the setting data sent at block 1503, storage manager system 110 can proceed to send block 1103. At send block 1103, storage manager system 110 can send command data for receipt by enterprise systems 140A-140Z. The command data sent at block 1103 can include command data comprising commands which, when executed, cause source data for persisting in an object storage system specified in the setting data sent at block 1503 to be accessed from an enterprise tenant resource. The command data sent at block 1103 can include command data comprising commands to embed metadata into source data sent from an enterprise to service endpoint 12 at subsequent send block 1402. The metadata can be, e.g., embedded in a payload of streamed data, embedded in a header of streamed data, and/or sent as an external catalog. The metadata can specify, e.g., tenant ID, an assigned identifier for the current object upload request, and setting data as input by a tenant agent user using user interface 4502.

On receipt of the command data sent at block 1103, enterprise system 140A-140Z can proceed to send block 1402. At send block 1402, appropriate ones of enterprise systems 140A-140Z can send to storage manager system 110 source data for persisting in an object storage system in accordance with setting data sent at block 1503 and the command data sent at block 1103.

On completion of send block 1103, storage manager system 110 can proceed to store block 1104. At store block 1104, storage manager system 110 can store into tenants area 2121 in association with an identifier (generated at send block 1102) for the current object upload request setting data associated to the request.

On receipt of the source data for persisting in an object storage system sent at block 1402, storage manager system 110 can proceed to examining block 1105. In one embodiment of send block 1402 source data can be streamed to a single service endpoint of an object storage system defined by service endpoint 12, with the endpoint serving as a centralized access point for all tenants. Streaming can be employed by system 100 for transfer of source data, such as logs, IoT data, or continuous backups, often using APIs that support streaming protocols or chunked transfers for large files. Authentication and routing at service endpoint 12 can ensure data is securely directed to the appropriate bucket or namespace. In some use cases source data can be uploaded at send block 1402 in batches or transferred as whole files, depending on the nature of the data and archiving process.

At examining block 1105, storage manager system 110 can perform examining of one or more of the source data for persisting in an object storage system sent at block 1402 or setting data sent at block 1503 specifying one or more action to perform with respect to the source data for persisting in an object storage system. In some cases, examining block 1105 can be performed without reference to any setting data, e.g., routing and possibly additional action decisions can be returned without receipt or examination of any tenant user defined setting data. In such a use case, storage and processing by object storage system 208 can be automatically adaptive independent of any setting data. At examining block 1105, storage manager system 110 can perform various processes. Examining to ascertain a data type of incoming source data for persisting in an object storage system can include, e.g., reading of heading data, examining of data attributes, reading of setting data that by setting data specified by agent user of an enterprise that specifies data type, and the like. Based on the data type, storage manager system 110 at action decision block 1106 can return an action decision to perform routing of the incoming source data for persisting in an object storage system into a particular one processing and storage infrastructure group for processing the incoming source data of the particular data type.

On completion of examining at examining block 1105, storage manager system 110 can proceed to action decision block 1106. At action decision block 1106, storage manager system 110 can return an action decision in dependence on the examining performed at examining block 1105.

An action decision returned to block 1106 can include, e.g., an action decision to select and route source data for persisting in an object storage system to a particular processing and storage infrastructure group of infrastructure groups 20A-20Z. In some instances, the action decision returned at block 1106 can include an action decision to perform additional processing for improved data storage, which enhanced data storage can include, e.g., the selectable processing functions summarized in Table 1, which processing functions can be made selectable with use of user interface 4502 of FIG. 4. An action decision returned at block 1106 can include an action decision to perform a sequence of processing functions based on setting data defined using area 4540 of user interface 4502.

On completion of action decision block 1106, storage manager system 110 can proceed to routing block 1107. At routing block 1107, storage manager system 110 can perform routing in accordance with an action decision returned at block 1106 to route incoming source data for persisting in an object storage system to an appropriate one processing and storage infrastructure group of stored infrastructure groups 20A-20Z.

As noted, each of the different processing and storage infrastructure groups 20A-20Z can include particularly configured processing infrastructure specially configured for performance of processing functions for processing source data of a data type associated with that group.

On completion of routing at routing block 1107, storage manager system 110 can proceed to processing block 1108. At processing block 1108, storage manager system 110 can perform processing specified by any processing function decision specified returned at action decision block 1106.

The processing at processing block 1108 can include processing in accordance with a processing function selected and configured by a user based on setting data defined by an agent user of a tenant enterprise with use of user interface 4502. Processing functions can be selected with setting data established using area 4520 of user interface 4502.

At processing block 1108, storage manager system 110 can, e.g., perform processing in accordance with selected processing functions selected using area 4520 of user interface 4502. In some use cases, processing at processing block 1108 can include processing of source data associated to a prior object upload request. As noted in reference to sequencing area 4540, some selected processing functions may not be configured for immediate execution, but may be part of a sequence of processing functions performed over time. At processing block 1108 can ascertain whether any processing functions associated to prior object upload requests are now ready to perform, e.g., based on a prior processing function of a selected sequence of processing functions having been performed.

On completion of processing at processing block 1108, storage manager system 110 can proceed to criterion decision block 1109. At criterion decision block 1109, storage manager system 110 can ascertain whether criterion has been satisfied for scaling stored resources of processing and storage infrastructure groups 20A-20Z. The criterion at criterion block 1109 can be, for example, according to one embodiment, that a predetermined scheduled calendar date for performing of scaling has been satisfied. According to another criterion at criterion block 1109, storage manager system 110 can determine that a scaling triggering condition has been satisfied by examining performance data of storage infrastructure of object storage system 208 as specified based on examining of observatory data stored within observatory data area 2122.

On completion of criterion block 1109, storage manager system 110 can proceed to recording block 1110. At recording block 1110, storage manager system 110 can record most recent demand indicating parameter values from a central observatory data volume of computer environment 200 into observatory data area 2122. Such observatory data can be time stamped to specify the current time such that in observatory data area there can be time series data that is time stamped to specify demand indicating parameter values over time.

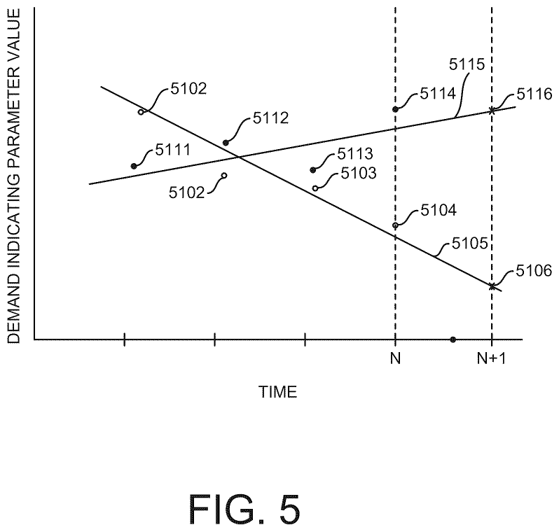

On completion of recording block 1110, storage manager system 110 can proceed to predicting block 1110. At predicting block 1110, storage manager system 110 can perform predicting by inferencing a trained machine learning model. In reference to FIG. 5, a trained machine learning model can be trained by training data provided by demand indicating parameter values. FIG. 5 depicts a regression-based machine learning predictive model trained with training data defined by demand indicating parameter values. The predictive model alternatively could be provided, e.g., by neural network.

In reference to FIG. 5, data points 5101-5104 refer to storage device demand indicating parameter values associated to a first processing and storage infrastructure group 20A of stored infrastructure groups 20A-20Z. Data points 5111-5114 refer to processing demand indicating parameter values associated to a second processing and storage infrastructure group 20B of stored infrastructure groups 20A-20Z.

To determine processing and storage device demand in an object storage system, key metrics for ascertaining processing demand can include request count/rate, latency, error rates, and the distribution of operation types (reads, writes, deletions). Monitoring node and cluster resource utilization such as CPU, memory, I/O operations, and network bandwidth is essential, as are metrics related to background processes like replication activity, data integrity checks, and garbage collection. Concurrency metrics, including active connections and thread/worker pool utilization, further highlight processing capacity. Such parameter values can be recorded at recording block 1110. The processing resource demand parameter value depicted in FIG. 5 can be one of the above types of parameter values, or can be a weighted aggregate of the above types of parameter values.

For ascertaining storage device demand, critical metrics can involve total storage utilization, growth rate, object count, and size distribution. Performance indicators like read/write throughput, storage latency, and I/O queue depth reveal storage device load. Data redundancy metrics such as replication factors and erasure coding, along with disk health metrics (errors, wear, and availability), are vital for assessing resiliency and capacity. Additionally, rates of archival and deletion influence storage dynamics, while derived metrics like hotspots, access patterns, and replication backlogs provide insights into system imbalances and scalability needs. By tracking these metrics holistically, you can identify bottlenecks, forecast future requirements, and optimize the storage system for performance and efficiency. Such parameter values can be recorded at recording block 1110. The storage resource demand parameter value depicted in FIG. 5 can be one of the above types of parameter values, or can be a weighted aggregate of the above types of parameter values.

At predicting block 1111, storage manager system 110 can redraw regression lines 5105 and 5115 based on the most recently recorded and indicating parameter values recorded at the most recent iteration of recording block 1110 and can perform inferencing of the regression lines to return predictions at predicting block 1111. The redrawing of regression lines 5105 and 5115 based on the most recently recorded and indicating parameter values can be regarded to be a training of a predictive model with training data provided by the parameter values. In reference to FIG. 5, data point 5106 refers to the predicted storage device demand for group 20A at time N+1, where the current time is time N. According to FIG. 5, data point 5116 is the predicted processing resource demand for group 20B group at time N+1 where time N is the current time.

Based on the predicted demand at the subsequent time N+1, storage manager system 110 can proceed to scaling block 1112. It will be understood that storage manager system 110 can be predicting processing and storage demand for all processing and storage groups 20A-20Z.

At scaling block 1112, storage manager system 110 can scale storage infrastructure resource processing and/or storage device resources independence on the predicting performed at block 1111. In the described embodiment described in reference to FIG. 5. storage manager system 110 at scaling block 1112 can scale down storage device resources of the first processing and storage infrastructure group and can scale up processing resources of the second described processing and storage infrastructure group based on the predicting that is depicted in FIG. 5.

Scaling at scaling block 1112 assures that storage infrastructure resources are not over allocated or under allocated. They are appropriately scaled to meet current demand. Embodiments herein recognize that the processing resource associated to each processing and storage infrastructure group 20A-20Z can differ substantially between the groups. As noted, some groups may benefit from powerful processors, such as graphics processors, and some groups may have associated thereto relatively smaller processors having smaller processing power. The scaling at scaling block 1112, in which scaling is perform differently, can be adapted differently amongst different processing and storage infrastructure groups 20A can assure that computing resources are not under allocated and are not over allocated. Embodiments herein recognize that breaking object storage system 208 into smaller resource groups and scaling them independently works better than managing a monolithic system because it offers greater scalability, cost efficiency, fault isolation, and flexibility. Embodiments herein recognize that independent scaling allows specific components to meet demand without over-provisioning the entire system, ensuring cost-effective resource allocation and reducing waste. Such scaling can isolate failures to specific components, preventing system-wide outages, while enabling fine-tuned optimization of resources for specific workloads, such as GPU-optimized servers for compute-heavy tasks or lightweight web servers for front-end operations. This approach also allows for the use of the best-suited technologies for each component, faster deployment cycles with reduced risk, and easier monitoring and debugging to pinpoint bottlenecks or issues.

By operation of the described scaling, storage manager system 110 can provide workload certified infrastructure (WCI) defined by processing and storage infrastructure groups 20A-20Z.

On completion of scaling block 1112, storage manager system 110 can proceed to return block 1113. Storage manager system 110 can also proceed to return block 1113 on the return of a no decision at criterion block 1109. At return block 1113, storage manager system 110 can return to stage preceding send block 1101 to receive a next iteration of request data sent at block 1501. Storage manager system 110 can iteratively perform the loop of block 1101-1113 for a deployment period of storage manager system. In regard to iterations of the loop of block 1101-1113 the sending of an installation package at block 1101 can be replaced with refreshes of the presented user interface 4502 for second and subsequent iterations after initial registration of a particular tenant. After a particular tenant has persisted source data within object storage system 208, data selection area 4512 can enable a user to select for performance of processing functions, source data already persisted within object storage system 208, e.g., drop down menu 4514 can present object names of objects of the tenant stored in object storage system for selection. The user using area 4520, 4530, and 4540 can selected a sequence of processing functions for the previously persisted source data. With use of sequence area 4540 a user can configure a multi-stage workflow defined by processing functions performed on source data that has been persisted in object storage system 208. Object storage system 208 avoids instances where an agent user of a tenant enterprise configures a range of computing resource consuming, high latency, manual and/or ad hoc data preparation processes prior to storage of their enterprise's source data within an object storage system.

Enterprise systems 140A-140Z on completion of send block 1402, can proceed to return block 1403. At return block 1403, enterprise systems 140A-140Z can return to stage preceding block 1401. Enterprise systems 140A-140Z can iteratively perform the loop at block 1401 to block 1403 for a deployment period of enterprise systems 140A-140Z.

UE devices 150A-150Z, on completion of send block 1503, can proceed to return block 1504. At return block 1504, UE devices 150A-150Z can return to a stage preceding send block 1501. UE devices 150A-150Z can iteratively perform the loop block 1501-1504 during a deployment period of UE devices 150A-150Z.

Embodiments herein recognize that source data for persisting in an object storage system in an object storage system can be generated from various data sources such as data sources of log backups, system backups, multi-media processing, and the like. Embodiments herein recognize that depending upon the data source or the client application, performance can benefit from specialized processing and storage of data. Embodiments herein recognize that in addition, it may be desirable for a customer to influence and customize how their application requests are handled and stored to optimize their workload.

Embodiments herein extend a storage class to include computational aspects of infrastructure to define a computational storage class (CSC).

According to one embodiment, object storage system 208 can be configured so that a service provider can certify infrastructure based on its capabilities to handle certain workloads. This infrastructure, which may be called as workload certified infrastructure (WCI), can include both compute and storage modules.

Some sample workloads include multimedia transcoding, compression, de-duplication, map-reduce, data cache etc. A service provider certifies infrastructure based on its capabilities to handle certain workloads.

This infrastructure, also called workload certified infrastructure (WCI), can be converged with both compute and storage modules. Some sample workloads include multimedia transcoding, compression, de-duplication, map-reduce, data cache etc., as set forth in further detail in reference to Table A. In accordance with aspects herein, a service provider can create a pool of infrastructure that are homogenous with respect to their workload certification also known as certified resource group (CRG) which can be defined by a storage infrastructure group 20A-20Z as set forth herein.

In one aspect, a service provider can advertise various computational storage classes (CSC) mapping to processing and storage infrastructure groups 20A-20Z that correspond to the various CRGs that a service provider has. A customer can specify the CSC at the time of bucket provisioning, e.g., using area 4530 of user interface 4502. In one aspect, object storage system 208 can provide a customer option to specify a CSC to match with their desired workload targeted for a bucket. Object storage system 208 configured as described can define an adaptive computation storage system (ACSS).

Embodiments herein can provide a computational storage class (CSC) provided by one of processing and storage infrastructure groups 20A-20Z that is advertised to customers to select infrastructure that has been certified to meet specific workload requirements.

Embodiments herein can provide an adaptive computational storage system (ACSS) that creates buckets leveraging certified infrastructure provided by processing and storage infrastructure groups 20A-20Z to meet the computational and storage requirements of customer workloads based on selected CSC(s).

Embodiments herein can provide an ACSS that provides bucket policy to define an initial CSC and then subsequent transition to another CSC based on triggers defined in the policy. In one example, with use of sequencing area 4540 of user interface, a user can input setting data to select a first processing function for performance by a first processing and storage infrastructure group of processing and storage infrastructure groups 20A-20Z followed by a second processing function for performance by a second processing and storage infrastructure group of processing and storage infrastructure groups 20A-20Z.

Embodiments herein can provide ability for a customer to choose a specific computational storage class. A customer can select a certified infrastructure for demanding workloads associated to source data defined by source datasets while at the same time having the ability to choose standard (non-certified) infrastructure for workloads that are not as demanding to minimize the cost. In reference to Table A, for example, a user can select processing and storage infrastructure group 20A for processing and storing more demanding multimedia workloads, and can select processing and storage infrastructure group 20D for processing and storing less demanding backup data workloads.

Additionally, the storage provider can certify and classify their infrastructure offerings defined by groups 20A-20Z to address advanced workloads. Moreover, the storage provider also can create a customer bucket leveraging the most appropriate infrastructure out of groups 20A-20Z to result in efficient usage of the infrastructure. A service provider can deploy and scale infrastructure defined by processing and storage infrastructure groups 20A-20Z that is finely tuned for customer specific workloads based on demand. Embodiments herein can move workloads from one CSC to another based on a customer defined storage class transition policy, e.g., as can be selected using sequencing area 4540 of user interface 4502.

An example workflow per the proposed mechanism is as set forth in Table B.

TABLE B
1. Customer creates a bucket selecting a CSC defined by a
particular one of processing and storage infrastructure groups
20A-20Z that matches their intended workload for the bucket.
2. Service Provider creates bucket and assigns resources from the
CRG that can serve the specified CSC.
3. Customer (client application) proceeds to send their
workload to the bucket.
4. Object storage system 208 selects the infrastructure from
the CRG designated to the bucket and processes the client workload.
5. The customer request is processed, and data stored using
infrastructure out of processing and storage infrastructure
groups 20A-20Z that is best suitable for the workload.
6. Customer workload may also be transitioned from
one CRG to another based on a defined CSC transition policy,
e.g., as can be selected using sequencing area 4540 of user interface 4502.

This results in customers availing use of the desired certified infrastructure for their workloads.

A sample use case is illustrated below in Table C.

TABLE C
1. A customer creates a bucket selecting with use of user interface 4502
one or more CSCs for, e.g., a ML CSC and multimedia processing CSC.
2. Customer workload deals with video analysis, e.g., automatic captions
transcription generation and video transcoding.
3. Customer defines the default (initial) CSC in the bucket policy
to leverage the ML CSC.
4. Customer using sequencing area 4520 of user interface 4502 sets
transition from ML CSC to Multimedia processing CSC based on
completion trigger of first CSC. Object storage system 110 in reference
case of Table B, can select machine learning processing and storage
to the use infrastructure group 20B for performance of transcription
processing function, and multimedia processing and storage infrastructure
group 20A for performance of the transcoding.
5. Video uploaded to bucket is first run through the ML processing CSC
by processing and storage infrastructure group 20B to generate
the closed captioning (subtitles).
One completion trigger video is then processed through the multimedia
processing CSC by processing and storage infrastructure group 20A
for to generate the video files that are transcoded in different formats.
6. Customer can execute entire workflow with a single upload without
having to pay for egress charges or additional storage costs for performing
multiple steps in the workflow.

Certain embodiments herein may offer various technical computing advantages involving computing advantages to address problems arising in computer systems. Embodiments herein can feature an object storage system that includes multiple differentiated processing and storage infrastructure groups. In one embodiment, the different processing and storage infrastructure groups can be differentiated in terms of their (a) processing infrastructure, (b) storage infrastructure and (c) the processing functions which they are configured to perform. Embodiments herein can feature an object storage system that presents to an agent user of a tenant enterprise a user interface to permit suer defining of setting data. The user interface can facilitate selections, e.g., of data sources for source data, processing functions, and processing and storage infrastructure groups. The user interface can further facilitate the providing the setting data that specifies sequences of processing functions. A sequence a processing functions established by an agent user of a tenant enterprise can specify, e.g., a first processing function by a first processing and storage resource group, and a second processing function by a second processing and storage infrastructure group. Embodiments herein can feature performance of processing and storage infrastructure scaling on an infrastructure group per infrastructure group basis resulting an improved performance (including in respect to fault tolerance) of the object storage system. Certain embodiments may be implemented by use of a cloud platform/data center in various types including a Software-as-a-Service (SaaS), Platform-as-a-Service (PaaS), Database-as-a-Service (DBaaS), and combinations thereof based on types of subscription.

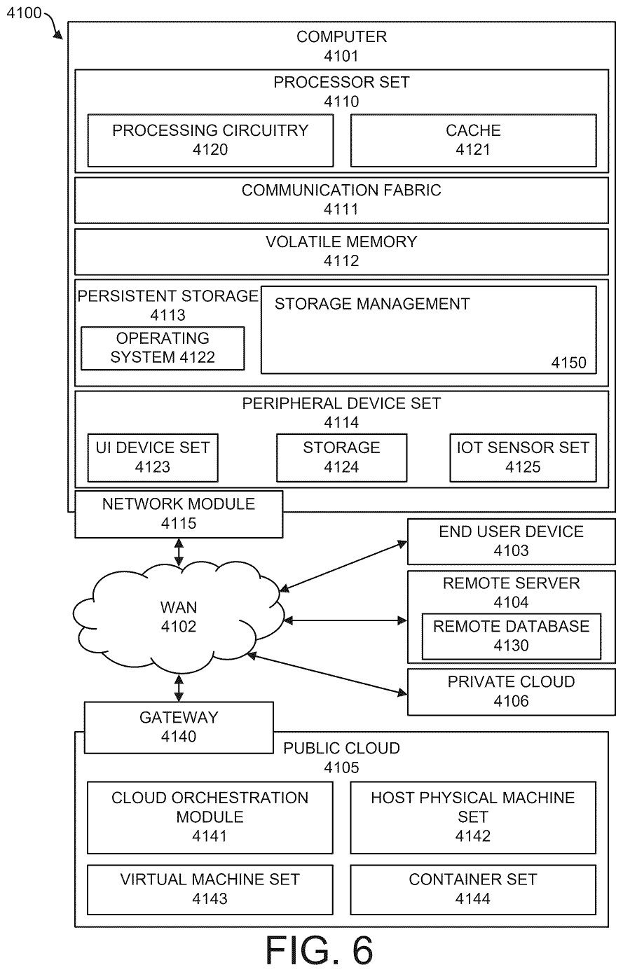

In reference to FIG. 6 there is set forth a description of a computing environment 4100 that can include one or more computer 4101. In one example, computing node 10 as set forth herein can be provided in accordance with computer 4101 as set forth in FIG. 6.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 6 In one aspect, a computing environment 4100 contains an example of an environment for the execution of at least some of the computer code involved in performing the inventive methods, such as code 4150 for performing storage management described with reference to FIGS. 1-5. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IoT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 1. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 may be a read only memory (ROM), but typically at least a portion of the persistent storage allows writing of data, deletion of data and re-writing of data. Some familiar forms of persistent storage include magnetic disks and solid state storage devices. Operating system 4122 may take several forms, such as various known proprietary operating systems or open source Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101), and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way, but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

1. A computer implemented method comprising:
receiving, by an object storage system, source data of a tenant, wherein the object storage system includes a first processing and storage infrastructure group, and a second processing and storage infrastructure group, wherein processing and storage infrastructure resources of the first processing and storage infrastructure group are differentiated from processing and storage infrastructure resources of the second first processing and storage infrastructure group;
examining setting data associated to the source data;
selecting, in dependence on the examining, one of the first or second processing and storage infrastructure group;
routing the source data to the selected one of the first or second processing and storage infrastructure group; and
storing the source data into a storage device of the selected one of the first or second processing and storage infrastructure group.

2. The computer implemented method of claim 1, wherein the method includes presenting to an agent user of the tenant a user interface, and receiving the setting data through the user interface.

3. The computer implemented method of claim 1, wherein the method includes presenting to an agent user of the tenant a user interface, and receiving the setting data through the user interface, wherein the setting data specifies a processing function to be performed on the source data, and wherein the method includes performing the processing function by a computing node of the selected one of the first or second processing and storage infrastructure group.

4. The computer implemented method of claim 1, wherein the method includes predicting subsequent demand for processing and storage infrastructure resources of the first infrastructure and storage infrastructure group in dependence on historical demand indicating parameter values, and scaling the processing and storage infrastructure resources of the first infrastructure and storage infrastructure group in dependence on the historical demand indicating parameter values.

5. The computer implemented method of claim 1, wherein the method includes predicting subsequent demand for processing and storage infrastructure resources of the first infrastructure and storage infrastructure group in dependence on historical demand indicating parameter values, and scaling the processing and storage infrastructure resources of the first infrastructure and storage infrastructure group in dependence on the historical demand indicating parameter values, wherein the predicting includes inferencing a trained machine learning model that has been trained with the historical demand indicating parameter values.

6. The computer implemented method of claim 1, wherein the method includes predicting subsequent demand for processing and storage infrastructure resources of the first infrastructure and storage infrastructure group in dependence on historical demand indicating parameter values, and scaling the processing and storage infrastructure resources of the first infrastructure and storage infrastructure group in dependence on the historical demand indicating parameter values, wherein the predicting includes inferencing a trained machine learning model that has been trained with the historical demand indicating parameter values, wherein the method includes predicting subsequent demand for processing and storage infrastructure resources of the second infrastructure and storage infrastructure group in dependence on second historical demand indicating parameter values, and scaling the processing and storage infrastructure resources of the second infrastructure and storage infrastructure group in dependence on the second historical demand indicating parameter values, wherein the predicting includes inferencing a machine learning model that has been trained with the second historical demand indicating parameter values.

7. The computer implemented method of claim 1, wherein the object storage system includes a third processing and storage infrastructure group, wherein processing and storage infrastructure resources of the third processing and storage infrastructure group is differentiated from processing and storage infrastructure resources of the first and the second processing and storage infrastructure group.

8. The computer implemented method of claim 1, wherein the receiving includes receiving the source data of the tenant through a service endpoint URL, wherein the object storage system includes a third processing and storage infrastructure group, and a second processing and storage infrastructure group, wherein processing and storage infrastructure resources of the third processing and storage infrastructure group is differentiated from processing and storage infrastructure resources of the first and the second processing and storage infrastructure group, wherein the method includes receiving second source data through the service endpoint URL, performing examining of setting data associated to the second source data, selecting the third processing and storage infrastructure group for receipt of the second source data, and routing the second source data to the third storage and infrastructure group for storage in dependence on the performing examining.

9. The computer implemented method of claim 1, wherein the receiving includes receiving the source data of the tenant through a service endpoint URL, wherein the object storage system includes a third processing and storage infrastructure group, wherein processing and storage infrastructure resources of the third processing and storage infrastructure group is differentiated from processing and storage infrastructure resources of the first and the second processing and storage infrastructure group, wherein the method includes receiving second source data through the service endpoint URL, performing examining of setting data associated to the second source data, selecting the third processing and storage infrastructure group for receipt of the second source data, and routing the second source data to the third storage and infrastructure group for storage in dependence on the performing examining, wherein the first processing and storage infrastructure group is a multimedia processing and storage infrastructure group configured to perform processing functions on multimedia data, wherein the second processing and storage infrastructure group is a machine learning processing and storage infrastructure group configured to perform processing functions on machine learning training data, wherein the third processing and storage infrastructure group is a backup data processing and storage infrastructure group configured to perform processing functions on backup data.

10. The computer implemented method of claim 1, wherein the receiving includes receiving the source data of the tenant through a service endpoint URL, wherein the object storage system includes a third processing and storage infrastructure group, wherein processing and storage infrastructure resources of the third processing and storage infrastructure group is differentiated from processing and storage infrastructure resources of the first and the second processing and storage infrastructure group, wherein the method includes receiving second source data through the service endpoint URL, performing examining of setting data associated to the second source data, selecting the third processing and storage infrastructure group for receipt of the second source data, and routing the second source data to the third storage and infrastructure group for storage in dependence on the performing examining, wherein the first processing and storage infrastructure group is a multimedia processing and storage infrastructure group configured to perform compression and transcoding processing functions on multimedia data, wherein the second processing and storage infrastructure group is a machine learning processing and storage infrastructure group configured to perform processing functions on machine learning training data, wherein the third processing and storage infrastructure group is a backup data processing and storage infrastructure group configured to perform processing functions on backup data.

11. The computer implemented method of claim 1, wherein the method includes presenting to an agent user of the tenant a user interface, and receiving the setting data through the user interface, wherein the setting data specifies a sequence of processing function to be performed on the source data, and wherein the method includes performing the sequence of processing functions, wherein the performing the sequence of processing functions includes performing by a computing node of the first processing and storage infrastructure group, a first of the sequence of processing functions, and performing by a computing node of the second processing and storage infrastructure group and subsequent second of the sequence of processing functions.

12. A system comprising:
a memory;
at least one processor in communication with the memory; and
program instructions executable by one or more processor via the memory to perform operations comprising:
receiving, by an object storage system, source data of a tenant, wherein the object storage system includes a first processing and storage infrastructure group, and a second processing and storage infrastructure group, wherein processing and storage infrastructure resources of the first processing and storage infrastructure group are differentiated from processing and storage infrastructure resources of the second processing and storage infrastructure group, the first processing and storage infrastructure group being configured to perform a first set of processing functions and the second processing and storage infrastructure group being configured to perform a second set of processing functions different from the first set of processing functions;
examining setting data associated to the source data;
selecting, in dependence on the examining, based on the setting data and on the first and second sets of processing functions, one of the first or second processing and storage infrastructure group;
routing the source data to the selected one of the first or second processing and storage infrastructure group; and
storing the source data into a storage device of the selected one of the first or second processing and storage infrastructure group.

13. The system of claim 12, wherein the operations include presenting to an agent user of the tenant a user interface, and receiving the setting data through the user interface, wherein the user interface is configured to present, for selection, processing functions associated respectively with the first set of processing functions and the second set of processing functions.

14. The system of claim 12, wherein the operations include presenting to an agent user of the tenant a user interface, and receiving the setting data through the user interface, wherein the setting data specifies a processing function to be performed on the source data, and wherein the operations include performing the processing function by a computing node of the selected one of the first or second processing and storage infrastructure group, the selected one being selected based on the specified processing function and on whether the specified processing function is included in the first set of processing functions or the second set of processing functions.

15. The system of claim 12, wherein the operations include predicting subsequent demand for processing and storage infrastructure resources of the first infrastructure and storage infrastructure group in dependence on historical demand indicating parameter values, and scaling the processing and storage infrastructure resources of the first infrastructure and storage infrastructure group in dependence on the historical demand indicating parameter values, wherein the predicting and scaling are performed with respect to the first processing and storage infrastructure group independently of predicting and scaling of the second processing and storage infrastructure group.

16. The system of claim 12, wherein the operations include predicting subsequent demand for processing and storage infrastructure resources of the first infrastructure and storage infrastructure group in dependence on historical demand indicating parameter values, and scaling the processing and storage infrastructure resources of the first infrastructure and storage infrastructure group in dependence on the historical demand indicating parameter values, wherein the predicting includes inferencing a trained machine learning model that has been trained with the historical demand indicating parameter values, wherein the historical demand indicating parameter values are associated with the first set of processing functions.

17. The system of claim 12, wherein the operations include predicting subsequent demand for processing and storage infrastructure resources of the first infrastructure and storage infrastructure group in dependence on historical demand indicating parameter values, and scaling the processing and storage infrastructure resources of the first infrastructure and storage infrastructure group in dependence on the historical demand indicating parameter values, wherein the predicting includes inferencing a trained machine learning model that has been trained with the historical demand indicating parameter values, wherein the operations include predicting subsequent demand for processing and storage infrastructure resources of the second infrastructure and storage infrastructure group in dependence on second historical demand indicating parameter values, and scaling the processing and storage infrastructure resources of the second infrastructure and storage infrastructure group in dependence on the second historical demand indicating parameter values, wherein the predicting includes inferencing a machine learning model that has been trained with the second historical demand indicating parameter values, wherein the historical demand indicating parameter values are associated with the first set of processing functions and the second historical demand indicating parameter values are associated with the second set of processing function.

18. The system of claim 12, wherein the object storage system includes a third processing and storage infrastructure group, wherein processing and storage infrastructure resources of the third processing and storage infrastructure group is differentiated from processing and storage infrastructure resources of the first and the second processing and storage infrastructure group, the third processing and storage infrastructure group being configured to perform a third set of processing functions different from the first set of processing functions and the second set of processing functions.

19. The system of claim 12, wherein the receiving includes receiving the source data of the tenant through a service endpoint URL, wherein the object storage system includes a third processing and storage infrastructure group, wherein processing and storage infrastructure resources of the third processing and storage infrastructure group are differentiated from processing and storage infrastructure resources of the first and the second processing and storage infrastructure groups, the third processing and storage infrastructure group being configured to perform a third set of processing functions different from the first set of processing functions and the second set of processing functions, wherein processing and storage infrastructure resources of the third processing and storage infrastructure group is differentiated from processing and storage infrastructure resources of the first and the second processing and storage infrastructure group, wherein the operations include receiving second source data through the service endpoint URL, performing examining of setting data associated to the second source data, selecting the third processing and storage infrastructure group for receipt of the second source data, and routing the second source data to the third storage and infrastructure group for storage in dependence on the performing examining.

20. A computer program product comprising:
a computer readable storage medium readable by one or more processing circuit and storing instructions for execution by one or more processor for performing operations comprising:
receiving, by an object storage system through a service endpoint URL, source data of a tenant, wherein metadata associated with the source data specifies setting data associated to the source data, wherein the object storage system includes a first processing and storage infrastructure group, and a second processing and storage infrastructure group, wherein processing and storage infrastructure resources of the first processing and storage infrastructure group are differentiated from processing and storage infrastructure resources of the second processing and storage infrastructure group;
examining the metadata including the setting data associated to the source data;
selecting, in dependence on the examining, one of the first or second processing and storage infrastructure group;
routing the source data to the selected one of the first or second processing and storage infrastructure group; and
storing the source data into a storage device of the selected one of the first or second processing and storage infrastructure group.
